(19) United States
(12) Patent Application Publication
(10) Pub. No.: US 2006/0272617 A1
(43) Pub. Date: Dec. 7, 2006

(54) Pressure control valve for a fuel injection system provided with an accumulator

(76) Inventors: Christian Braeuer, Steyr (AT); Stefan Holl, Ottnang (AT)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/556,288

(22) PCT Filed: Mar. 31, 2004
(86) PCT No.: PCT/DE04/00659

§ 371 Date: Nov. 9, 2005

(30) Foreign Application Priority Data
May 16, 2003 (DE) 103 22 127.1

(51) Int. Cl. F02M 59/36

(52) U.S. Cl. 123/458

(57) ABSTRACT

A pressure regulating valve for a reservoir-type fuel injection system for internal combustion engines serves to regulate the pressure in a fuel reservoir (common rail). The pressure regulating valve is designed in simplified form; the fuel reservoir is embodied as a closed reservoir and its supply and return lines are disposed inside a liquid level in such a way that without further action by the pressure regulating valve, it is not possible for the fuel reservoir to run empty.

The invention relates to a pressure regulating valve for a reservoir-type fuel injection system for internal combustion engines for regulating the pressure in a fuel reservoir, having a pistonlike valve member, guided axially displaceably in a bore, that acts in the closing direction on a closing element and presses it against a valve seat, and the valve member forms an armature of an electromagnet that can be supplied with current.

Such pressure regulating valves are known in many versions. This pressure regulating valve serves to regulate the pressure in a fuel reservoir. The pressure regulating valve has a pistonlike valve member, which is guided axially displaceably in a bore counter to the force of preferably a closing spring. The valve member acts in the closing direction on a closing element of the pressure regulating valve and presses it against a valve seat. The valve member forms an armature of an electromagnet, which can be supplied with current to reinforce the force of the closing spring.

By means of the closing spring, via the valve member, the closing element is pressed with a defined force against the valve seat; by means of the pressure acting on it in the fuel reservoir, the closing element is lifted from the valve seat when the force generated by the pressure exceeds the force of the closing spring, and fuel flows out of the fuel reservoir into a relief chamber via the opened pressure regulating valve.

When a higher pressure is established in the fuel reservoir, the electromagnet is supplied with current, so that the closing force that is exerted on the closing element via the valve member is increased, and thus the closing element lifts from the valve seat only at a higher pressure in the fuel reservoir, and only then can fuel flow out of the fuel reservoir into the relief chamber.

### OBJECT OF THE INVENTION

It is the object of the invention to refine the pressure regulating valve known from the prior art further in such a way that it can be manufactured at lower cost.

Attainment of the Object

The key concept in attaining the object is to locate the fuel reservoir, with its inlet and return on both sides, in such a way that the inlet and return are below a liquid level, so that automatic emptying, particularly in the currentless state (corresponding to stoppage of the engine) is not possible. As a result, a spring—of the kind known from the prior art—that generates the additional axial forces when the pressure regulating valve is not subject to current can be omitted.

Further advantageous features will become apparent from the ensuing description as well as the drawing.

### DRAWING

Shown is

FIG. 1, a section through the pressure regulating valve of the invention along with its location relative to the fuel reservoir and the fuel tank.

### DESCRIPTION OF AN EXEMPLARY EMBODIMENT

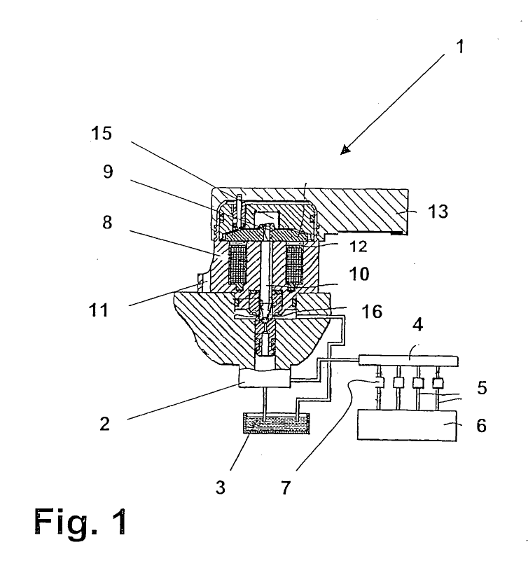

In FIG. 1, a longitudinal section through a pressure regulating valve 1 is shown. In addition, a reservoir-type fuel injection system for internal combustion engines, in particular self-igniting internal combustion engines, is shown. The reservoir-type fuel injection system, also known as a common rail injection system, has a high-pressure pump 2, by which fuel is pumped at high pressure from a fuel tank 3 into a fuel reservoir 4. The fuel reservoir 4 is embodied for instance in tubular form, as a so-called rail. From the fuel reservoir 4, lines 5 lead to the injection locations of an internal combustion engine 6, in each of which a respective valve 7 is disposed. For setting the pressure in the fuel reservoir 4, the pressure regulating valve 1 is provided, which may be disposed at the outlet of the high-pressure pump 2 or at the fuel reservoir 4.

The pressure regulating valve 1 itself has a valve 8, in which a bore 9 is embodied in which a pistonlike valve member 10 is disposed axially displaceably. A securing flange 11 is embodied on the valve body 8, and by way of it the valve body can be secured to the high-pressure pump 2 or to the fuel reservoir 4. In addition, a further chamber inside the valve body 8 is provided, in which an electromagnet 12 with a coil winding is disposed. A connection element 13 that covers the chamber of the valve body is provided on the valve body 8. In the prior art, a spring which exerts a force on the valve member 10 is provided in the connection element, in a recess 15. Supplying current to the electromagnet 12 causes the valve member 10 to be pressed further against the valve seat 16 shown here, so that the lines are correspondingly closed.

Mode of Operation

When no current is supplied to the electromagnet 12, the valve member 10 rests by its own weight on the valve seat 16, and the valve seat 16 is acted upon by the pressure in the fuel reservoir 4. Because of the weight of the valve member 10, a force is created which is greater than that generated by the fuel reservoir 4, and so the valve is closed. When the pressure regulating valve 1 is opened, fuel flows out of the fuel reservoir 4 through the valve seat 16, for instance into a relief chamber, in this case a fuel tank 3.

If the pressure in the fuel reservoir 4 is to be increased, then current is supplied to the electromagnet 12, so that the valve seat 16 remains closed even if the pressure is elevated.

Thus in a very simple way, solely by the disposition of a relief tank 3 or fuel reservoir 4, one component of a pressure reservoir valve 1 known per se can be eliminated, thus reducing costs and making installation simpler.

1. (canceled)

2. A pressure regulating valve for a reservoir-type fuel injection system for internal combustion engines for regulating the pressure in a fuel reservoir, comprising
a valve body,
a pistonlike valve member, guided axially displaceably in a bore in the valve body and acting in the closing direction on a closing element and presses it against a valve seat,
the valve member forming an armature of an electromagnet that can be supplied with current, and
the fuel reservoir being a closed reservoir, whose supply and return lines are disposed below a liquid level that is defined by the location of the pressure regulating valve.
